(19) United States
(12) Patent Application Publication
(10) Pub. No.: US 2025/0222517 A1
(43) Pub. Date: Jul. 10, 2025

(54) METHOD FOR MANUFACTURING A TIMEPIECE OR JEWELLERY COMPONENT, AND SAID TIMEPIECE OR JEWELLERY COMPONENT

(71) Applicant: PATEK PHILIPPE SA GENEVE, Genève (CH)

(72) Inventors: Julien PERRET, Andilly (FR); Nicholas HENDRICKS, Zürich (CH); Alba FINELLI, Fribourg (CH); Vaclav PEJCHAL, Morges (CH)

(21) Appl. No.: 18/854,002

(22) PCT Filed: Apr. 3, 2023
(86) PCT No.: PCT/EP2023/058653

§ 371 Date: Oct. 3, 2024

(30) Foreign Application Priority Data
Apr. 6, 2022 (EP) 22166956.7

(51) Int. Cl. B22F 9/24; A44C 27/00; B22F 1/16; B33Y 70/10; B33Y 80/00; G04B 37/22

(52) U.S. Cl. CPC B22F 9/24; A44C 27/003; B22F 1/16; B33Y 70/10; B33Y 80/00; G04B 37/22; B22F 2301/255; B22F 2302/25; B22F 2304/056

(57) ABSTRACT

The present invention relates to a method for manufacturing a timepiece or jewellery component from a material comprising at least 18 carats of gold, comprising the following steps:
a) producing Au@metal oxide nanoparticles, step a) comprising at least the sub-steps of a1) synthesising gold nanoparticles that have dimensions and shapes giving them a plasmonic effect; aa2) mixing the gold nanoparticles from step a1) with a surfactant comprising functional groups for coupling to the metal oxide, while maintaining a plasmonic effect; a3) forming the metal oxide shell, while maintaining a plasmonic effect;
b) producing a semi-finished product from a material comprising at least 18 carats of gold using the Au@metal oxide nanoparticles from step a), while maintaining a plasmonic effect, the semi-finished product having a colour such that the difference ΔE in the CIE Lab colour space between the colour of the obtained semi-finished product and the colour of the Au@metal oxide nanoparticles formed in step a), in the dry state, is less than 10; and
c) producing the timepiece or jewellery component from said material comprising at least 18 carats of gold using the semi-finished product obtained in step b), while maintaining a plasmonic effect.

The present invention also relates to a timepiece or jewellery component obtained by the manufacturing method as defined above, said timepiece or jewellery component being obtained using a semi-finished product that has a colour defined in the CIE L*a*b space by the parameters −5<a*<5, −5<b*<5 and L*<15.

### TECHNICAL FIELD

The present invention relates to a method for manufacturing a timepiece or jewellery component from a material comprising at least 18 carats of gold, that is to say comprising at least 75% of gold by weight relative to the total weight of the material.

The present invention also relates to a semi-finished product for the production of a timepiece or jewellery component, and said timepiece or jewellery component which is likely to be obtained by means of said manufacturing method.

### PRIOR ART

Gold alloys are commonly used in the manufacture of timepiece or jewellery components, in the form of a deposited coating or in a solid form. These alloys are traditionally yellow, red or grey in colour. Gold alloys, which are coloured to distinguish them from the original colour of the gold, can be obtained by the traditional metallurgical route, or by using gold nanoparticles coated with at least one layer of metal oxide, such as silicon, zirconium or titanium oxide, based on the plasmonic effect of the gold nanoparticles. The notation Au@metal oxide is used to refer to such gold nanoparticles covered with a metal oxide shell. In fact, the gold nanoparticles (typically ranging in size from 2 to 200 nm) have a plasmonic effect. The plasmonic effect consists of a vibration of the electron cloud of the nanoparticles when they are exposed to an electromagnetic field. More specifically, under the influence of the oscillating electric field of light, the free electrons of a metal nanoparticle undergo oscillations with respect to the metal network. At certain frequencies, that is to say at certain wavelengths, these oscillations acquire a large amplitude through the phenomenon of resonance. This is called plasmon resonance (simplification of localised surface plasmon resonance, LSPR). Light absorption is greatest at resonance frequencies. Following absorption, the surface plasmons lose their energy radiatively (light diffusion), or non-radiatively (in the form of heat).

This plasmonic effect gives the gold nanoparticles extremely attractive optical properties. LSPRs result in resonances in the visible range. It is therefore possible to excite them with visible light, and they play a major role in the colour properties of the nanoparticles. LSPRs depend in particular on the size and shape of the nanoparticle. For example, for nanospheres, the resonances of gold are located around 520 nm in aqueous solution and vary little for sizes ranging from 2 to 50 nm. These nanoparticles appear ruby red. However, the position of the absorption band and its width and, therefore, the colour evolve depending on the size of the nanoparticles: when this increases, the LSPR band moves towards long wavelengths and widens. The colour varies not only according to the size of the nanoparticles but also according to their shape which depends on the conditions of production. For elongated nanoparticles, such as the nanorods, the plasmon resonance shifts into the red as the aspect ratio increases. The gold nanoparticles can therefore change colour from red to purple depending on their size. Other colours such as green and blue can be obtained by playing with the shape factor, with more or less elongated nanoparticles (rods).

Patent EP 1 887 052 describes a piece composed of a pigmented ceramic, the pigment being composed of gold nanoparticles for example, coated with crystalline silica. The piece obtained is in the red range. The quantity of pigments in the ceramic is less than 5% by weight. This document does not therefore describe any component containing at least 75% gold by weight.

Patent EP 2 369 022 describes a method for manufacturing a solid material comprising at least 12 carats or even 18 carats of gold, formed from gold nanoparticles covered with silica. The colour of the gold nanoparticles used is adjusted according to the size, geometry (spherical, cylindrical and pyramidal), composition and the chemical environment of the nanoparticles. The solid material is obtained by sintering by heating associated with microwave radiation, which makes it possible to not alter the specific colouring of the gold nanoparticles used. However, the preparation of a solution of gold nanoparticles of bright red colour is described, the solution of gold nanoparticles covered with silica being purple in colour, and the pellet obtained following heating and microwave irradiation being black in colour. The described method does not therefore make it possible to guarantee that the colour of the nanoparticles is preserved, and is therefore not sufficiently robust.

Application EP 3 482 851 describes a method for manufacturing a material comprising at least 18 carats of gold, formed by an assembly of gold nanoparticles in a matrix of titanium dioxide. However, this method is complex because it requires the use of solvents and the heating of the mixture formed in the reactor. Furthermore, because of the significant absorption or non-ideal optical properties for light transmission of the titanium dioxide, the penetration depth of light through the material is not sufficient to obtain the maximum plasmonic effect of the gold nanoparticles, such that the colour of the material obtained is not a deep black. In addition, it is indicated that the powder obtained is black in colour prior to the compacting and sintering steps, whereas following these two steps, the material is anthracite in colour. The initial colour of the nanoparticles is therefore altered. Moreover, the mechanical properties of the titanium dioxide, such as the hardness, are not always sufficient to meet the imposed specifications according to the components.

The present invention aims to remedy these drawbacks by proposing a method for manufacturing a timepiece or jewellery component from a material comprising at least 18 carats of gold, which makes it possible to guarantee that the colour of the nanoparticles used is preserved and stable.

Another object of the present invention is to propose a method for manufacturing a timepiece or jewellery component, which makes it possible to obtain a composite component comprising at least 18 carats of gold and having very good mechanical properties.

Another object of the present invention is to propose a method for manufacturing a timepiece or jewellery component from a material comprising at least 18 carats of gold, which makes it possible to obtain, in a simple manner, a dark-coloured component, grey or black, and, in particular, deep black.

### DISCLOSURE OF THE INVENTION

To this end, the invention relates to a method for manufacturing a timepiece or jewellery component from a material comprising at least 18 carats of gold, said method comprising the following steps:
a) producing a solution of Au@metal oxide nanoparticles comprising a gold core covered with a metal oxide shell, step a) comprising at least the sub-steps of:
   a1) synthesising gold nanoparticles by reacting a gold precursor with a reducing agent, said gold nanoparticles having dimensions and shapes giving them a plasmonic effect at least in the visible range;
   a2) mixing the gold nanoparticles obtained in step a1) with a solution of a surfactant comprising functional groups for coupling to the metal oxide and maintaining stirring for a sufficient time so that said surfactant coats the gold nanoparticles, while maintaining a plasmonic effect;
   a3) forming the metal oxide shell by reacting a metal oxide precursor with the gold nanoparticles obtained in sub-step a2), while maintaining a plasmonic effect;
b) producing a semi-finished product from a material comprising at least 18 carats of gold using the solution obtained in step a) with a view to forming said timepiece or jewellery component, while maintaining a plasmonic effect, the obtained semi-finished product having a colour such that the difference ΔE in the CIE Lab colour space between the colour of the obtained semi-finished product and the colour of the Au@metal oxide nanoparticles formed in step a), in the dry state, is less than 10, preferably less than or equal to 8;
c) producing the timepiece or jewellery component from said material comprising at least 18 carats of gold using the semi-finished product obtained in step b), while maintaining a plasmonic effect.

Thus, the method according to the invention makes it possible to not alter and to preserve the colour of the synthesised gold nanoparticles, in particular during the procurement of the semi-finished product, and to obtain a component comprising at least 18 carats of gold having substantially the same colour as the synthesised gold nanoparticles at the outset, this colour advantageously being black.

The present invention also relates to a semi-finished product from a material comprising at least 18 carats of gold which is likely to be obtained during the implementation of the method for manufacturing a timepiece or jewellery component as defined above, said semi-finished product having a colour defined in the CIE L*a*b space by the parameters −5<a*<5, −5<b*<5 and L*<15, preferably −1<a*<1, −1<b*<1 and L*<13.

The present invention also relates to a timepiece or jewellery component which is likely to be obtained by the manufacturing method as defined above, said timepiece or jewellery component being obtained using a semi-finished product that has a colour defined in the CIE L*a*b space by the parameters −5<a*<5, −5<b*<5 and L*<15.

### BRIEF DESCRIPTION OF THE DRAWINGS

Other characteristics and advantages of the present invention will appear on reading the following detailed description of different embodiments of the invention, provided by way of non-limiting examples, and with reference to the appended drawings, wherein:

FIG. 1 schematically shows the steps of a first variant of the method according to the invention;

FIG. 2 schematically shows the steps of a second variant of the method according to the invention;

FIG. 3 is an image obtained by transmission electron microscopy (TEM-scale 20 nm) of the Au@metal oxide nanoparticles obtained according to step a) of the method according to the invention; and

FIG. 4 shows reflectance curves of Au@SiO₂ nanoparticles, which are black in colour, obtained according to step a) of the method of the invention.

### EMBODIMENTS OF THE INVENTION

The present invention relates to a method for manufacturing a timepiece or jewellery component from a material comprising at least 18 carats of gold, that is to say at least 75% of gold by weight relative to the total weight of the material.

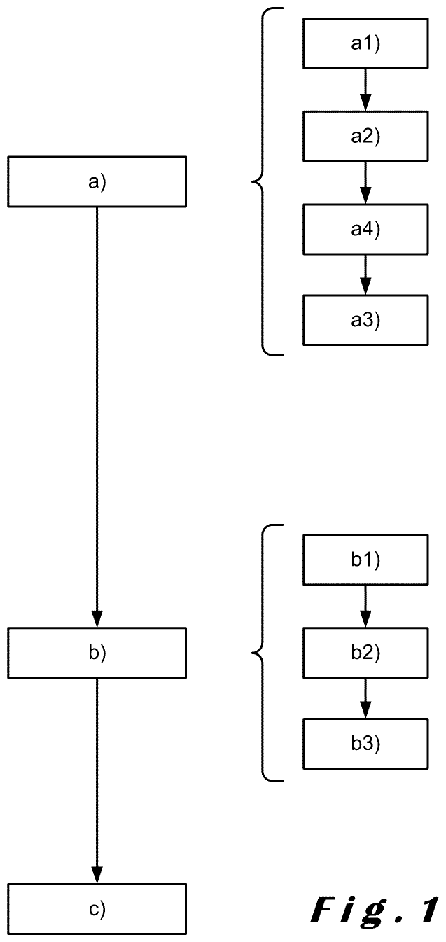

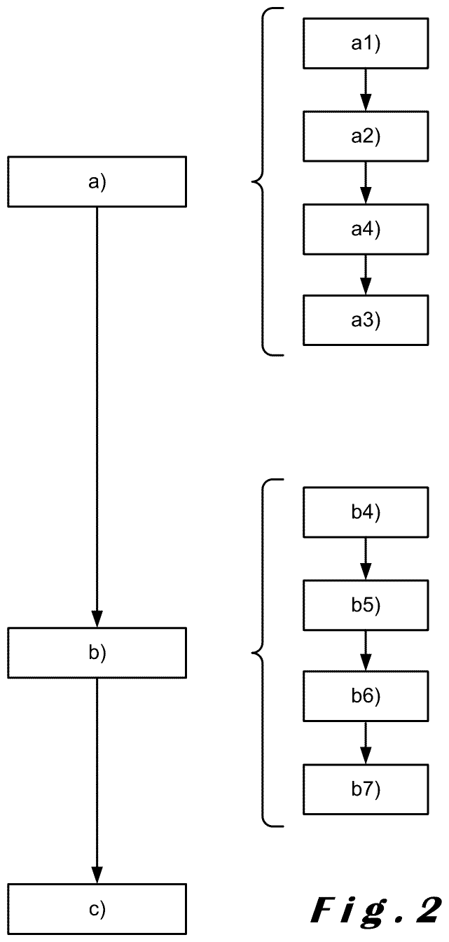

In accordance with the invention and with reference to FIGS. 1 and 2, said method comprises the following steps:
a) producing a solution of Au@metal oxide nanoparticles comprising a gold core covered with a metal oxide shell, step a) comprising at least the sub-steps of:
   a1) synthesising gold nanoparticles in solution by reacting a gold precursor with a reducing agent, said gold nanoparticles having dimensions and shapes giving them a plasmonic effect at least in the visible range corresponding to a predetermined colour X;
   a2) mixing the solution of gold nanoparticles obtained in step a1) with a solution of a surfactant comprising functional groups for coupling to the metal oxide and maintaining stirring for a sufficient time so that said surfactant coats the gold nanoparticles, while maintaining a plasmonic effect, the nanoparticles obtained having a colour X1;
   a3) forming the metal oxide shell by reacting a metal oxide precursor with the gold nanoparticles obtained in sub-step a2), while maintaining a plasmonic effect, the Au@metal oxide nanoparticles formed having a colour X2 measured, in the dry state, in powder form, such that the colour difference ΔE in the CIE Lab colour space between the colours X1 and X2 is preferably less than 8, preferably less than or equal to 5, more preferably less than 3 or even less than 1, the colour difference ΔE in the CIE Lab colour space between the colours X and X2 preferably being less than 8, preferably less than 5, more preferably less than 3, or even less than 1;
b) producing a semi-finished product from a material comprising at least 18 carats of gold using the solution obtained in step a) with a view to forming said timepiece or jewellery component, while maintaining a plasmonic effect, the obtained semi-finished product having a colour X3 such that the difference ΔE in the CIE Lab colour space between the colours X2 and X3 is less than 10, preferably less than or equal to 8 and, more preferably, less than or equal to 7, the difference ΔE in the CIE Lab colour space between the colours X and X3 preferably being less than 10, more preferably less than or equal to 8 and, more preferably, less than or equal to 7;
c) producing the timepiece or jewellery component from said material comprising at least 18 carats of gold using the semi-finished product obtained in step b), while maintaining a plasmonic effect, said obtained timepiece or jewellery component having a colour X4 such that the difference ΔE in the CIE Lab colour space between the colours X2 and X4 is preferably less than 10, preferably less than or equal to 8 and, more preferably, less than or equal to 7, and the difference ΔE in the CIE Lab colour space between the colours X and X4 is preferably less than 10, more preferably less than or equal to 8 and, more preferably, less than or equal to 7.

The colour difference or the colour deviation ΔE in the CIE Lab colour space is defined as a measure of difference between two colours by equation (I):

$$Δ {E}^{*} = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}} \qquad ( I )$$

L₁*, a₁*, b₁* are the coordinates in the CIE Lab colour space of the first colour to be compared and L₂*, a₂*, b₂* are the coordinates in the CIE Lab colour space of the second colour to be compared.

A colour difference ΔE between two colours less than 10, preferably less than or equal to 8 and, more preferably, less than or equal to 7 indicates that the two colours are virtually identical, at least the one is not altered with respect to the other.

The synthesis of gold nanoparticles by reducing a gold precursor is a synthesis known to the person skilled in the art, who knows how to select the different parameters such as the concentrations of the reagents, the concentration ratios, the solvents, the synthesis method with heating, reflux, etc., in order to obtain gold nanoparticles that have identical or different dimensions and shapes, selected to give said gold nanoparticles a global plasmonic effect at least in the visible range corresponding to the predetermined colour X. In fact, the colour of the gold nanoparticles varies according to the size and the shape of the nanoparticles. Colours from red to purple can be obtained depending on the size, generally with spherical nanoparticles, whereas colours such as green and blue can be obtained by playing with the shape factor, with for example more or less elongated nanoparticles, in the form of rods. It is also possible to have cube, star shapes, etc. In particular, it is possible to control the size of the particles by playing with the gold/reducing agent ratio. The gold nanoparticles obtained in sub-step a1) preferably have dimensions less than 200 nm, and preferably between 1 nm and 200 nm and, more preferably, between 20 nm and 200 nm. There are numerous publications on different methods for synthesising gold nanoparticles, which make it possible to control the size and the shape of said gold nanoparticles in order to obtain the predetermined colour X.

Advantageously, in sub-step a1), the gold precursor is a gold salt such as HAuCl₄, preferably in aqueous solution, in concentrations of between 2 g/l and 10 g/l.

Advantageously, in sub-step a1), the reducing agent can be NaBH₄ or sodium citrate, preferably in the form of an aqueous solution, in concentrations of between 25 g/l and 75 g/l. Sodium citrate is preferred. Such a reducing agent has the advantage of also having the role of stabiliser, which makes it possible to maintain the gold nanoparticles in solution.

Sub-step a1) preferably comprises mixing an aqueous solution of the gold precursor with an aqueous solution of reducing agent with a molar ratio of gold/reducing agent in solution of between 1/50 and 1/20 at ambient temperature of 25° C.

During sub-step a2), the surfactant used, in addition to its properties of coupling to the metal oxide, is preferably a stabilising agent for the gold nanoparticles prepared in sub-step a1). It is advantageously amphiphilic, soluble in water and in organic solvents. In addition to its functional groups for coupling to the metal oxide, such as C═O groups, it comprises functional groups CH₂, providing hydrophobicity, and C—N groups, for example a pyrrolidone group, giving it its hydrophilic character.

The surfactant is preferably selected from the group comprising polyvinylpyrrolidone (PVP), gelatines, silane derivatives and silicate derivatives.

The colour X1 of the nanoparticles obtained in step a2) can be identical to or different from the colour X of the nanoparticles obtained in step a1) depending on the surfactant concentration.

The gold nanoparticles/surfactant solution is preferably continually vigorously stirred for between 6 hours and 12 hours, that is to say the time necessary to replace the reducing agent with the surfactant and to protect the gold nanoparticles.

The surfactant is preferably polyvinylpyrrolidone (PVP). The PVP used during sub-step a2) advantageously has a molar mass of between 5000 g/mol and 20 000 g/mol and is in the form of an aqueous solution in concentrations of between 1 g/l and 10 g/l.

The molar ratio of gold/PVP in solution is preferably between 1/1 and 3/1.

When the surfactant is PVP, the solution of gold nanoparticles/PVP is preferably continually vigorously stirred for between 6 hours and 12 hours, that is to say the time necessary to replace the citrate with PVP and to protect the gold nanoparticles. The PVP is a surfactant that prevents the agglomeration and sedimentation of the nanoparticles due to its hydrophobic alkyl functions and its hydrophilic pyrrolidone group. In addition, in a particularly advantageous manner for the present invention, PVP has a better affinity with silica, for example, undoubtedly due to its C═O function.

The nanoparticles protected by the surfactant and, in particular, by the PVP are then collected for sub-step a3) or preferably for the intermediate sub-step a4). In fact, in a particularly preferred manner, step a) comprises an intermediate sub-step a4) between sub-step a2) and sub-step a3) comprising the elimination of the excess surfactant and, in particular, the excess PVP. To do this, the nanoparticles obtained in sub-step a2) are collected and concentrated by centrifugation prior to being implemented during sub-step a3). In a particularly advantageous manner, this centrifugation step makes it possible to wash the nanoparticles prior to being resuspended in alcohol as will be described below. This washing makes it possible to control the thickness of the metal oxide shell and, more particularly, the thickness of the silica oxide shell in order to obtain nanoparticles with oxide shells having a uniform thickness.

According to sub-step a3), the metal oxide is preferably selected from the group comprising silicon oxide, zirconium oxide and titanium oxide. The silicon oxide is particularly preferred. Nanoparticles comprising a gold core covered with a shell of silica oxide, or zirconium oxide or titanium oxide are thus synthesised. Preferably, nanoparticles comprising a gold core with a silica or zirconium oxide shell and, more preferably, nanoparticles comprising a gold core with a silica oxide shell are synthesised.

The metal oxide precursor can be selected from the group comprising tetraethoxysilane for a silica shell, titanium butoxide for a titanium dioxide shell and zirconium butoxide for a zirconia shell. Other precursors can be used. In order to preferably obtain a silica shell, the silicon oxide precursor is advantageously tetraethoxysilane (TEOS) in alcoholic solution (for example, ethanol). The reaction is based on Stöber synthesis and is catalysed by ammonia. The gold nanoparticles protected by the surfactant and, in particular, by the PVP, recovered in sub-step 2) or, preferably, in sub-step a4) are transferred into a solution of alcohol and ammonia, as described above. Then, an alcoholic solution of oxide precursor is immediately added, drop by drop, while being vigorously stirred. The reaction is preferably stopped after 3 hours. The Au@metal oxide nanoparticles obtained are then collected in order to be kept in solution to be used in sub-step b1) or dried in powder form in accordance with sub-step b4), as described below. The Au@metal oxide nanoparticles obtained can also be collected to be dried in powder form, then dissolved again to be used in sub-step b1).

The parameters of the method of sub-step a3) are selected so as to form a metal oxide shell and, preferably, a silicon oxide shell, for which a plasmonic effect is maintained, the Au@oxide nanoparticles formed having a colour X2, measured when the Au@oxide nanoparticles are in powder form in the dry state. In particular, the surfactant concentration is preferably selected so that the colour difference ΔE in the CIE Lab colour space between the colours X and X1, X1 and X2, and X and X2 is preferably less than 8, preferably less than 5, preferably less than or equal to 3 and, more preferably, less than or equal to 1 such that the initial colour of the gold nanoparticles prepared in sub-step a1) is preserved.

In particular, the thickness of the shell can vary depending on the oxide/gold precursor ratio or the reaction time. Because of their affinity with the silica, the surfactants used and, in particular, PVP advantageously make it possible to obtain a uniform silica shell around the gold nanoparticles.

The thickness of the shell is preferably less than 100 nm, and preferably between 2 nm and 50 nm and, more preferably, between 10 nm and 40 nm, the main thing being that the colour X2 of the Au@oxide nanoparticles obtained is not altered and is preserved with respect to the colour X of the gold nanoparticles prepared initially.

According to a particularly preferred embodiment, sub-step a1) comprises mixing an aqueous solution of the gold precursor, preferably HAuCl₄, with an aqueous solution of sodium citrate with a molar ratio of gold/sodium citrate in solution of between 1/50 and 1/20 at ambient temperature of 25° C. in order to prepare gold nanoparticles of black colour X defined in the CIE L*a*b space by the parameters −5<a*<5, −5<b*<5 and 0≤L*<10, preferably −1<a*<1, −3<b*<3 and 0≤L*<6.

In a particularly advantageous manner, the reaction is performed at ambient temperature (25° C.) without any energy input. A colloid of reticular nanostructured gold formed of interconnected gold crystals is obtained in order to provide compact gold nanoparticles of different sizes between 40 nm and 200 nm and of different shapes (nanospheres, cluster, etc.) of black colour X defined above. The frequency of the photons absorbed by the black gold nanoparticles strongly depends on the shape and size of the nanoparticles according to the LSPR effect. Thus, the polydisperse and multiform gold nanoparticles obtained can absorb light in a wide range, which gives them a black colour as defined above.

These black gold nanoparticles are then preferably prepared with the PVP according to sub-steps a2) and a4). The molar ratio of gold/PVP in solution is between 1/1 and 3/1.

The more the nanoparticles solution is diluted in the PVP, the more the black colour of the nanoparticles is maintained. The more the solution is concentrated in PVP, the more the PVP will tend to control the shape and size of the nanoparticles by breaking the nanostructured reticular shape of the gold, giving a reddish colour.

The black gold nanoparticles preferably prepared with the PVP are then used to form Au@metal oxide nanoparticles and, preferably, Au@silicon oxide or Au@zirconium oxide nanoparticles according to sub-step a3) of colour X2. The PVP concentration is selected such that the colour X2 is preferably similar to the colour X, such that the black colour X of the gold nanoparticles is preserved and is not altered.

Following the preparation of a solution of Au@metal oxide nanoparticles according to step a), the Au@metal oxide nanoparticles can be used in the form of a solution or dried in powder form. For this, the Au@metal oxide nanoparticles of the solution obtained in step a) are washed several times, for example with alcohol such as ethanol, then collected by centrifugation. The Au@metal oxide nanoparticles, preferably Au@silicon oxide or Au@zirconium oxide nanoparticles, are then dried for at least 6 hours, and preferably at least 12 hours, for example in a furnace at 60° C.

Au@metal oxide nanoparticles are used in solution or powder form to obtain the quantity of gold needed to produce a semi-finished product from a material comprising at least 18 carats of gold with a view to forming said timepiece or jewellery component.

The surfactant and, in particular, the PVP, and the appropriate metal oxide shell make it possible to maintain a plasmonic effect, the obtained semi-finished product having a colour X3 such that the difference ΔE in the CIE Lab colour space between the colours X2 and X3 is less than 10, preferably less than or equal to 8, more preferably less than or equal to 7. When the colour X2 is similar to the colour X1 which is itself similar to the colour X, there is therefore also a difference ΔE in the CIE Lab colour space between the colours X and X3 which is less than 10, more preferably less than or equal to 8, more preferably less than or equal to 7.

According to a first variant of the method of the invention, step b) for producing the semi-finished product consists of a method selected from the group comprising a 3D printing method, a method involving exposure to radiation, for example UV or microwave radiation, and a combination thereof.

According to another variant of the method of the invention, step b) for producing the semi-finished product comprises the sub-steps of:
b1) mixing gold and metal oxide nanoparticles, preferably Au@silicon oxide or Au@zirconium oxide nanoparticles, obtained in step a), said gold and metal oxide nanoparticles being in solution as obtained directly in step a), in powder form if they have been dried in an intermediate step after step a) or dissolved again if they have been previously dried in powder form, with a flowable preceramic polymer, the quantity of Au@metal oxide nanoparticles being selected so as to obtain a composite fluid comprising at least 18 carats of gold. The flowable preceramic polymer is preferably fluid, with a viscosity of 10 to 30 cP, for example. The mixing can be done with a planetary mixer or by ultrasound;
b2) shaping the composite fluid obtained in sub-step b1) so as to form the semi-finished product;
b3) performing a pyrolysis of the composite fluid shaped according to sub-step b2) in order to obtain the semi-finished product of colour X3. The pyrolysis or sintering can be performed at high temperatures, for example of between 1000° C. and 1600° C., in an inert environment (argon or nitrogen) for a period of between, for example, 6 hours and 12 hours, and with rises and falls in temperature of between 10° C./h and 25° C./h.

The preceramic polymer used during sub-step b1) is preferably selected from the group comprising polycarbosiloxanes, polycarbosilanes, polysilazanes, polycarbosilazanes, polysilanes and polysilsesquiazanes to form polymer-derived ceramics (PDC), respectively silicon oxycarbide, silicon carbide, silicon nitride, silicon carbonitride, silicon oxynitride by pyrolysis. Other preceramic polymers, in particular comprising boron, can also be used. The PDC is advantageously selected to be more transparent than the gold following pyrolysis such that the light interacts more with the gold than with the pyrolysed PDC. Furthermore, when the colour X of the gold nanoparticles is the colour black, the PDC is selected to be black in colour following the pyrolysis when it is used alone, without black Au@metal oxide nanoparticles.

Sub-step b2) can be advantageously implemented by using a 3D printing method.

Sub-step b2) can also consist of a method selected from the group comprising a method involving exposure to radiation such as UV or microwave radiation, a casting method, a press-forming method and an injection moulding method preferably preceded by a ball milling, by using a mould suitable for the component to be manufactured to do this, for example a PTFE mould, in order to obtain at the end of sub-step b2) a raw compact semi-finished product traditionally called a near-net-shape “green body”, that is to say very close to the final shape of the component to be manufactured. The shaping of the fluid according to sub-step b2) can in particular be done by cold casting, by injection press moulding or by cold extrusion. The shaping of the fluid according to sub-step b2) can also be done by press-forming or hot isostatic pressing by heating the product in its mould at 300° C. at 60 MPa for 30 min. The product is removed from the mould and then possibly heated again at 400° C. at 60 MPa for 6 hours.

According to another variant of the method of the invention, step b) for producing the semi-finished product comprises the sub-steps of:
b4) preparing a powder using a solution of gold and metal oxide nanoparticles, preferably Au@silicon oxide or Au@zirconium oxide nanoparticles, obtained in step a). For this, the Au@metal oxide nanoparticles, preferably Au@silicon oxide or Au@zirconium oxide nanoparticles, of the solution obtained in step a) are washed several times, for example with alcohol such as ethanol, then collected by centrifugation. The Au@metal oxide nanoparticles, preferably Au@silicon oxide or Au@zirconium oxide nanoparticles, are then dried for at least 6 hours and, preferably, at least 12 hours, for example in a furnace at 60° C.;
b5) mixing said powder obtained according to sub-step b4) with a ceramic so as to obtain a composite powder comprising at least 18 carats of gold, the quantity of Au@metal oxide nanoparticles being selected so as to obtain a composite powder comprising at least 18 carats of gold;
b6 shaping the composite powder obtained in sub-step b5) so as to form the semi-finished product;
b7) performing a pyrolysis of the composite powder shaped according to sub-step b6) in order to obtain the semi-finished product of colour X3. The pyrolysis can be performed as described above for sub-step b3).

The ceramic used in sub-step b5) is preferably selected from the group comprising zirconia, alumina, silicon oxycarbide, silicon carbide, silicon nitride, silicon carbonitride, silicon oxynitride, titanium carbide, titanium nitride, titanium diboride, boron carbide. The ceramic is advantageously selected to be more transparent than the gold following the pyrolysis such that the light interacts more with the gold than with the pyrolysed ceramic. Furthermore, when the colour X of the gold nanoparticles is the colour black, the ceramic is selected to be black in colour following the pyrolysis when it is used alone, without black Au@metal oxide nanoparticles. The ceramic makes it possible to obtain a composite material comprising at least 18 carats of gold having very good mechanical properties, the ductility, hardness and toughness being improved compared to a pure gold.

Sub-step b6) is advantageously implemented by a traditional method for implementing ceramics. Sub-step b6) can consist, for example, of a method selected from the group comprising a casting method, a press-forming method and an injection moulding method, via the formation of a green body, for example, as described above for sub-step b2).

Finally, step c) of producing the timepiece or jewellery component comprises, for example, a mechanical machining and/or finishing treatment in order to obtain said timepiece or jewellery component of colour X4 such that the difference ΔE in the CIE Lab colour space between the colours X3 and X4 is preferably less than 10, preferably less than or equal to 8 and, more preferably, less than or equal to 7, and such that the difference ΔE in the CIE Lab colour space between the colours X2 and X4 is preferably less than 10, preferably less than or equal to 8 and, more preferably, less than or equal to 7. The mechanical machining treatment is, for example, a milling method or any other appropriate method. The mechanical finishing treatment is, for example, a polishing method or any other appropriate method. When the colour X2 is similar to the colour X1 which is itself similar to the colour X, there is therefore also a difference ΔE in the CIE Lab colour space between the colours X and X4 which is less than 10, more preferably less than or equal to 8 and, more preferably, less than or equal to 7.

A timepiece or jewellery component from a material comprising at least 18 carats of gold and, in particular, a composite material of the Cermet type combining ceramic and metal, and having all the attractive mechanical properties of ceramics, in particular ductility, hardness and toughness, is thus obtained.

Nanoparticles comprising a gold core with a silicon or zirconium oxide shell are preferably used, and nanoparticles comprising a gold core with a silica oxide shell are more preferably used.

A silica or zirconium oxide shell around the gold core has several advantages:
in the case of black gold nanoparticles, the alloys will attain a darker colour because of the more effective penetration depth of light thanks to a better association of the refractive indices between the metal oxide shell and the gold core. The interaction of light at the interface of the metal oxide shell and the gold core will increase in the solid material because of the lower refractive index of the silicon dioxide or the zirconium dioxide compared to the refractive index of the titanium dioxide;
the lower refractive index of the silicon dioxide or the zirconium dioxide is also an advantage for obtaining 18-carat gold alloys of different colours, for example red, blue, purple and green;
the mechanical properties will be improved by using a silicon dioxide or zirconium dioxide shell rather than a titanium dioxide shell because of an increase in the Vickers hardness. The overall mechanical strength of the final component obtained will thus be improved and the scratch resistance increased;
the lower density of the silicon dioxide compared to that of the titanium dioxide will make it possible to obtain a gold alloy with a higher gold fineness than that obtained with a titanium dioxide shell.

Moreover, the surfactant and, in particular, the PVP, due to its affinity with the metal oxide, and, in particular, with the silica or zirconium, makes it possible to obtain a uniform silica or zirconia shell around the gold nanoparticles. This uniform shell advantageously makes it possible to prevent the fusion of the gold nanoparticles during the subsequent heat treatments such as the pyrolysis, such that the plasmonic effect of the gold nanoparticles is preserved and that at least the colour X2 of the prepared Au@metal oxide nanoparticles is not altered by the different heat treatments needed to obtain the semi-finished product of colour X3, the difference ΔE in the CIE Lab colour space between the colours X3 and X2 being less than 10, preferably less than or equal to 8 and, more preferably, less than or equal to 7. Furthermore, the colour X2 of the prepared Au@metal oxide nanoparticles is advantageously not altered by the different heat treatments needed to obtain the timepiece or jewellery component of colour X4, the difference ΔE in the CIE Lab colour space between the colours X2 and X4 preferably being less than 10, preferably less than or equal to 8 and, more preferably, less than or equal to 7. When the colour X2 is similar to the colour X1 which is itself similar to the colour X, it is the initial plasmonic effect and the initial colour X of the gold nanoparticles which are preserved, the difference ΔE in the CIE Lab colour space between the colours X and X3 being less than 10, more preferably less than or equal to 8 and, more preferably, less than or equal to 7, and the difference ΔE in the CIE Lab colour space between the colours X and X4 preferably being less than 10, more preferably less than or equal to 8 and, more preferably, less than or equal to 7.

In a particularly preferred method of the invention, sub-step a1) comprises mixing an aqueous solution of the gold precursor (HAuCl₄) with an aqueous solution of sodium citrate with a molar ratio of gold/sodium citrate in solution of between 1/50 and 1/20 at ambient temperature of 25° C., the surfactant used in sub-step a2) is polyvinylpyrrolidone (PVP) in aqueous solution, the molar ratio of gold/PVP in solution being between 1/1 and 3/1, and the metal oxide precursor used in sub-step a3) is tetraethoxysilane in alcoholic solution. In step a) Au@SiO₂ nanoparticles are obtained, having, in the dry state in powder form, a black colour X2 defined in the CIE L*a*b space by the parameters −5<a*<5, −5<b*<5 and 0≤L*<10, preferably −1<a*<1, −3<b*<3 and 0≤L*<6, the semi-finished product obtained in step b) being of colour X3 defined in the CIE L*a*b space by the parameters −5<a*<5, −5<b*<5 and 0≤L*<15, preferably −1<a*<1, −1<b*<1 and 0≤L*<13, and the timepiece or jewellery component obtained in step c) preferably being of colour X4 defined in the CIE L*a*b space by the parameters −5<a*<5, −5<b*<5 and 0≤L*<15, preferably −1<a*<1, −1<b*<1 and 0≤L*<13.

The present invention also relates to a semi-finished product from a material comprising at least 18 carats of gold which is likely to be obtained during the implementation of the method for manufacturing a timepiece or jewellery component as defined above, said semi-finished product having a colour defined in the CIE L*a*b space by the parameters −5<a*<5, −5<b*<5 and L*<15, preferably −1<a*<1, −1<b*<1 and L*<13.

The present invention also relates to a timepiece or jewellery component which is likely to be obtained by the manufacturing method as described above, and obtained using a semi-finished product that has a colour defined in the CIE L*a*b space by the parameters −5<a*<5, −5<b*<5 and 0≤L*<15, preferably −1<a*<1, −1<b*<1 and 0≤L*<13, said timepiece or jewellery component preferably having a colour defined in the CIE L*a*b space by the parameters −5<a*<5, −5<b*<5 and 0≤L*<15, preferably −1<a*<1, −1<b*<1 and 0≤L*<13.

Such a timepiece or jewellery component is, for example, an oscillating mass, an external element of a watch, a jewel.

The following example illustrates the present invention without, however, limiting the scope thereof.

### EXAMPLE

A citrate solution (A) comprising 54.4 ml of Milli-Q water and 2.72 g of sodium citrate is prepared. A gold solution (B) comprising 28 ml of Milli-Q water and 136 mg of HAuCl₄ 3H₂O is prepared. A solution of PVP (C) comprising 630 ml of Milli-Q water and 1.55 g of PVP (10K) is prepared.

Solution A is poured into solution B and the reaction is constantly stirred for 10 minutes. The synthesised colloid of black gold is then poured into solution C and continually vigorously stirred overnight. The black gold nanoparticles are collected by centrifugation and are transferred into a solution of EtOH and of ammonia (6 ml EtOH +0.375 ml of ammonia). A solution of TEOS in EtOH (4 ml EtOH+0.27 ml TEOS) is immediately added, drop by drop, and vigorously stirred. The reaction is stopped after 3 hours. The Au@silicon oxide (Au@SiO₂) nanoparticles are then washed 3 times with EtOH and collected by centrifugation in order to be finally dried in the furnace at 60° C. overnight.

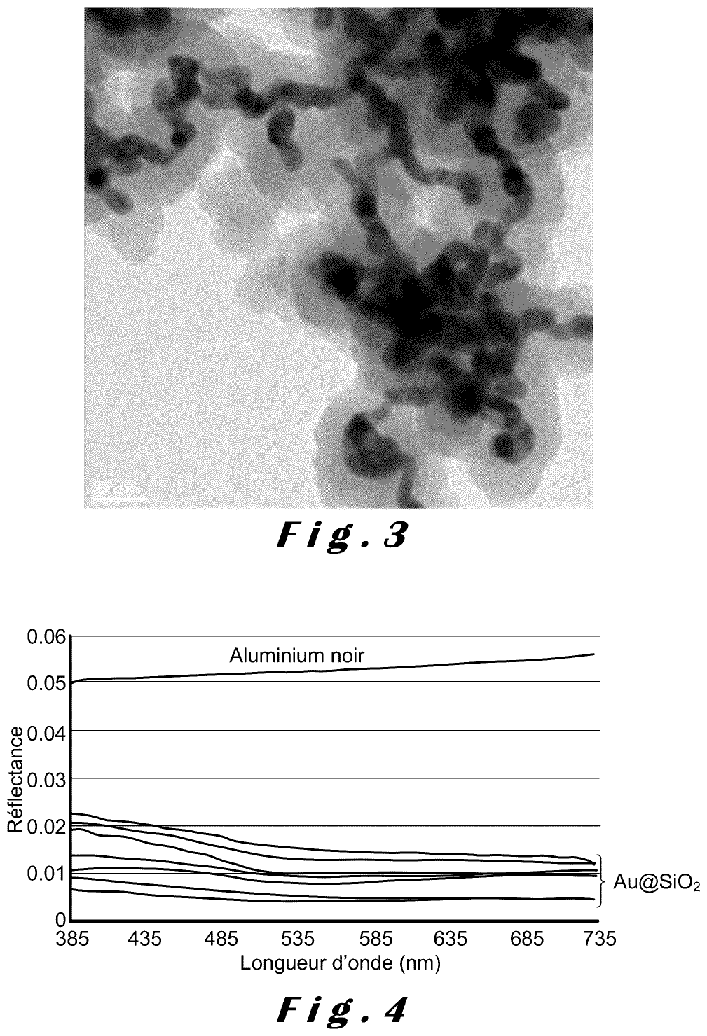

The Au@silicon oxide nanoparticles obtained are characterised by transmission electron microscopy (TEM). FIG. 3 shows that the Au@silicon oxide nanoparticles obtained are in the form of multiform, compact reticular gold coated by a silica shell. The dimensions of the nanoparticles are between 3 and 100 nm, with an approximately 12 nm thick silica shell.

The Au@SiO₂ nanoparticles in solution obtained in step a) are dried in powder form, by several washes with ethanol, centrifugation then dried for 12 hours in a furnace at 60° C.

The Au@silicon oxide nanoparticles in the form of dry powder have a colour X2 defined in the CIE L*a*b space by the parameters a*=0.4, b*=−2.8, L*=5.5, the measurements being carried out with an i1Pro3, a piece of equipment made by X-Rite. The reflectance of the Au@SiO₂ nanoparticles is measured by the piece of equipment made by X-Rite, the i1Pro3, for seven samples. By comparison, the reflectance of a black aluminium sheet is measured. The curves depicted in FIG. 4 are obtained, which correspond very well to Au@SiO₂ nanoparticles which are black in colour.

The Au@SiO₂ nanoparticles are then compacted by hot isostatic pressing (HIP) at 300° C., at 667 bar for 1 hour. The Au@SiO₂ nanoparticles have an intermediate colour X′ defined in the CIE L*a*b space by the parameters a*=0.6, b*=−0.5, L*=13.6. The ΔE in the CIE Lab colour space between X2 and X′ is 8.4.

The pyrolysis is then performed in order to obtain a semi-finished product containing 18 carats of gold of colour X3 defined in the CIE L*a*b space by the parameters a*=0.2, b*=−0.9, L*=12.7. The ΔE in the CIE Lab colour space between X3 and X2 is 7.4. The ΔE with respect to the compacted state after HIP, between X3 and X′, is approximately 1.

This shows that the pyrolysis of the Au@SiO₂ nanoparticles does not alter the colour of the Au@SiO₂ nanoparticles obtained during the previous manufacturing steps. In particular, the colour of the synthesised Au@SiO₂ nanoparticles is preserved and is not altered.

Furthermore, gold nanoparticles and Au@SiO₂ nanoparticles which are very black are obtained, and, therefore, a component from a composite material comprising 18 carats of gold and a ceramic, for which the initial black colour of the gold nanoparticles has been preserved and is not altered, are obtained.

1. A method for manufacturing a timepiece or jewelry component from a material including at least 18 carats of gold, said method comprising the following steps:
(a) producing a solution of Au@metal oxide nanoparticles comprising a gold core covered with a metal oxide shell, step a) comprising at least the sub-steps of:
a1) synthesizing gold nanoparticles by reacting a gold precursor with a reducing agent, said gold nanoparticles having dimensions and shapes giving the gold nanoparticles a plasmonic effect at least in the visible range,
a2) mixing the gold nanoparticles obtained in step a1) with a solution of a surfactant comprising functional groups to couple to metal oxide, and maintaining stirring for a sufficient time so that said surfactant coats the gold nanoparticles, while maintaining the plasmonic effect, and
a3) forming the metal oxide shell by reacting a metal oxide precursor with the gold nanoparticles obtained in sub-step a2), while maintaining the plasmonic effect;
b) producing a semi-finished product from the material comprising at least 18 carats of gold using the solution of Au@metal oxide nanoparticles obtained in step a), while maintaining the plasmonic effect, the obtained semi-finished product having a color such that the difference ΔE in the CIE Lab color space between the color of the obtained semi-finished product and the color of the Au@metal oxide nanoparticles formed in step a), in the dry state, is less than 10; and
producing the timepiece or jewelry component from said material comprising at least 18 carats of gold using the semi-finished product obtained in step b), while maintaining the plasmonic effect.

2. The manufacturing method according to claim 1, wherein step a) comprises an intermediate sub-step a4) between sub-step a2) and sub-step a3) comprising eliminating the excess surfactant.

3. The manufacturing method according to claim 1, wherein the surfactant is selected from the group consisting of polyvinylpyrrolidone (PVP), gelatines, silane derivatives, and silicate derivatives.

4. The manufacturing method according to claim 1, wherein step b) consists of a method selected from the group consisting of a three-dimensional (3D) printing method and a radiation exposure method.

5. The manufacturing method according to claim 1, wherein step b) comprises the sub-steps of:
b1) mixing the gold and metal oxide nanoparticles obtained in step a) with a flowable preceramic polymer se as to obtain a composite fluid comprising at least 18 carats of gold,
b2) shaping the composite fluid obtained in sub-step b1) to form the semi-finished product, and
b3) performing a pyrolysis of the composite fluid shaped according to sub-step b2) in order to obtain the semi-finished product.

6. The manufacturing method according to claim 5, wherein the flowable preceramic polymer is selected from the group consisting of polycarbosiloxanes, polycarbosilanes, polysilazanes, polycarbosilazanes, polysilanes, and polysilsesquiazanes to form polymer-derived ceramics, respectively silicon oxycarbide, silicon carbide, silicon nitride, silicon carbonitride, and silicon oxynitride.

7. The manufacturing method according to claim 5, wherein sub-step b2) consists of a method selected from the group consisting of a three-dimensional (3D) printing method, a radiation exposure method, a casting method, a press-forming method, and an injection molding method.

8. The manufacturing method according to claim 1, wherein step b) comprises the sub-steps of:
preparing a powder using the solution of gold and metal oxide nanoparticles obtained in step a),
mixing said obtained powder with a ceramic to obtain a composite powder comprising at least 18 carats of gold,
shaping the obtained composite powder to form the semi-finished product, and
performing a pyrolysis of the shaped composite powder in order to obtain the semi-finished product.

9. The manufacturing method according to claim 8, wherein the ceramic is selected from the group consisting of zirconia, alumina, silicon oxycarbide, silicon carbide, silicon nitride, silicon carbonitride, silicon oxynitride, titanium carbide, titanium nitride, titanium diboride, and boron carbide.

10. The manufacturing method according to claim 8, wherein the shaping consists of a method selected from the group consisting of a casting method, a press-forming method, and an injection molding method.

11. The manufacturing method according to claim 1, wherein step c) comprises a mechanical machining and/or finishing treatment in order to obtain said timepiece or jewelry component.

12. The manufacturing method according to claim 1, wherein the gold nanoparticles obtained in sub-step a1) have dimensions less than 200 nm.

13. The manufacturing method according to claim 1, wherein the reducing agent is NaBH₄ or sodium citrate.

14. The manufacturing method according to claim 1, wherein sub-step a1) comprises mixing an aqueous solution of the gold precursor with an aqueous solution of the reducing agent with a molar ratio of gold/reducing agent in solution of between 1/50 and 1/20 at ambient temperature of 25° C.

15. The manufacturing method according to claim 1, wherein the metal oxide shell has a thickness of less than 100 nm.

16. The manufacturing method according to claim 1, wherein the gold precursor is a gold salt.

17. The manufacturing method according to claim 1, wherein the metal oxide precursor is selected from the group consisting of tetraethoxysilane for a silica shell, titanium butoxide for a titanium dioxide shell, and zirconium butoxide for a zirconia shell.

18. The manufacturing method according to claim 1, wherein sub-step a1) comprises mixing an aqueous solution of the gold precursor with an aqueous solution of sodium citrate with a molar ratio of gold/sodium citrate in solution of between 1/50 and 1/20 at ambient temperature of 25° C., the gold nanoparticles obtained in sub-step a1) having a black color defined in the CIE L*a*b space by the parameter −5<a*<5, −5<b*<5 and L*<10.

19. The manufacturing method according to claim 1, wherein sub-step a1) comprises mixing an aqueous solution of the gold precursor with an aqueous solution of sodium citrate with a molar ratio of gold/sodium citrate in solution of between 1/50 and 1/20 at ambient temperature of 25° C.,
the surfactant used a2) is in sub-step polyvinylpyrrolidone (PVP) in aqueous solution, the molar ratio of gold/PVP in solution being between 1/1 and 3/1, and
the metal oxide precursor used in sub-step a3) is tetraethoxysilane in alcoholic solution, in order to obtain Au@SiO₂ nanoparticles having, in the dry state, a color defined in the CIE L*a*b space by the parameters −5<a*<5, −5<b<5 and L*<10, the color of the semi-finished product obtained in step b) being defined in the CIE L*a*b space by the parameters −5<a*<5, −5<b<5 and L*<15.

20. A semi-finished product from a material including at least 18 carats of gold obtained during the method for manufacturing a timepiece or jewelry component according to claim 1, wherein said semi-finished product has a color defined in the CIE L*a*b space by the parameters −5<a*<5, −5<b<5 and L*<15.

21. A timepiece or jewelry component obtained by the manufacturing method according to claim 1 using the semi-finished product that has a color defined in the CIE L*a*b space by the parameters −5<a*<5, −5<b<5 and L*<15.

22. The timepiece or jewelry component according to claim 21, comprising an oscillating mass, an external element of a watch, and a jewel.
